(19) United States
(12) Patent Application Publication
(10) Pub. No.: US 2023/0056286 A1
(43) Pub. Date: Feb. 23, 2023

(54) SYSTEM AND METHOD FOR SERVICE ENABLEMENT AND RESOURCE ALLOCATION IN STORAGE FACILITIES

(71) Applicant: Grey Orange Inc., Roswell, GA (US)

(72) Inventors: Pareiya Gupta, Gurgaon (IN); Kumar Devvrat, Gurgaon (IN); Hritik Soni, Jaipur (IN)

(73) Assignee: Grey Orange Inc., Roswell, GA (US)

(21) Appl. No.: 17/445,576

(22) Filed: Aug. 20, 2021

(51) Int. Cl. H04L 12/927; H04L 12/923; H04L 12/911

(52) U.S. Cl. CPC H04L 47/808; H04L 47/762; H04L 47/781; H04L 47/826

(57) ABSTRACT

A system for enablement of services and resource allocation in a storage facility is provided. The system includes a plurality of resources and a server. The server stores an identifier and historical data of an item, and receives the identifier associated with the item. The server identifies a default lifecycle of the item and allocates a first set of resources to each predefined process of the default lifecycle. The server detects a value-added service requirement and selects a value-added service based on the detected value-added service requirement. The server modifies the default lifecycle of the item by introducing the selected value-added service in the default lifecycle, identifies and allocates a second set of resources from the plurality of resources to execute the selected value-added service.

### FIELD

The present disclosure relates generally to resource management, and more particularly, to a system and a method for service enablement and resource allocation in storage facilities.

### BACKGROUND

Electronic commerce (e-commerce) has changed the way customers purchase items. As e-commerce continues to grow at a significant pace, overtaking conventional brick and mortar retail practices, many businesses are facing notable challenges of maintaining relevance in an online marketplace and competing with prominent players in the space. Modern storage facilities handle a large number of inventory items on a daily basis. Examples of such inventory items may include groceries, apparels, electronics, or the like. Such storage facilities typically receive a very high volume of items which needs to be processed for various purposes such as stocking, replenishment, fulfillment, or the like. Handling of each inventory item in the storage facility may involve a few defined processes, these processes could be same or different for different types of items. Besides, these processes could change on the basis of changing business needs and real-time requirements, and would need to be updated over time. However, updating these processes in real time becomes difficult when the storage facility has a high movement of items.

Conventionally, the processes associated with each item follows a linear workflow, where each process occurs in a sequence defined by the workflow. However, at times, changes may be required within the workflow or a process to accommodate changing business needs and real-time requirements. However, modifying the defined workflow, or resource allocation may impact other ongoing processes in the storage facility that may in turn impact a throughput of the storage facility and cause additional loses.

In light of the foregoing, there exists a need for a reliable solution that enables updating of linear workflow of items on real-time requirement basis, while seamlessly managing resources to accommodate the change.

Limitations and disadvantages of conventional and traditional approaches will become apparent to one of skill in the art, through comparison of described systems with some aspects of the present disclosure, as set forth in the remainder of the present application and with reference to the drawings.

### SUMMARY

Embodiments of the present disclosure provide a system for enablement of services and resource allocation in a storage facility. The system includes a plurality of resources associated with the storage facility and a control server. The control server may be configured to store therein, an identifier and historical data of an item. The historical data may include at least one of a default lifecycle of the item and one or more value-added services historically executed with respect to the item. The control server may be configured to receive the identifier associated with the item. The control server may be further configured to identify, from the historical data, the default lifecycle of the item based on the received identifier. The default lifecycle may include one or more predefined processes. The control server may be configured to allocate a first set of resources from the plurality of resources to each of the one or more predefined processes for execution of each of the one or more predefined processes. The control server may be configured to detect, in real-time, a value-added service requirement during the execution of at least one of the one or more predefined processes and select, from the one or more value-added services, a value-added service based on the detected value-added service requirement. Further, the control server may be configured to modify the default lifecycle of the item by introducing the selected value-added service subsequent to at least one of the one or more predefined processes. Further, the control server may be configured to identify a second set of resources from the plurality of resources to execute the selected value-added service, based on at least one of a first set of attributes associated with each resource of the second set of resources, a second set of attributes associated with the selected value-added service, and a third set of attributes associated with the item. Further, the control server may be configured to allocate the identified second set of resources to the selected value-added service.

Embodiments of the present disclosure provide a system for enablement of services and resource allocation in a storage facility. The system includes a plurality of resources associated with the storage facility and a control server. The control server may be configured to store therein an identifier and historical data of an activity. The historical data may include at least one of a default lifecycle of the activity and one or more value-added services historically executed with respect to the activity. Further, the control server may be configured to receive the identifier associated with the activity. The control server may be configured to identify, from the historical data, the default lifecycle of the activity based on the received identifier. The default lifecycle may include one or more predefined processes. Further, the control server may be configured to allocate a first set of resources from the plurality of resources to each of the one or more predefined processes for execution of the one or more predefined processes. The control server may be configured to detect, in real-time, a value-added service requirement during an execution of at least one of the one or more predefined processes and select, from the one or more value-added services, a value-added service based on the detected value-added service requirement. Further, the control server may be further configured to modify the default lifecycle of the activity by introducing the selected value-added service subsequent to at least one of the one or more predefined processes. The control server may be configured to identify a second set of resources from the plurality of resources to execute the selected value-added service, based on at least one of a first set of attributes associated with each resource of the second set of resources, a second set of attributes associated with the selected value-added service, and a third set of attributes associated with the activity. The control server may be configured to allocate the identified second set of resources to the selected value-added service.

In some embodiments, the first set of resources may be allocated to each of the one or more predefined processes based on a capability of each resource of the first set of resources to execute a corresponding predefined process of the one or more predefined processes.

In some embodiments, the second set of resources may be allocated to the selected value-added service based on a capability of each resource of the second set of resources to execute the selected value-added service.

In some embodiments, the first set of attributes may include at least one of a numerical count of the resources in the second set of resources, a capacity, an availability, a condition, a type, a capability, and a real-time location of each resource of the second set of resources. The second set of attributes may include at least one of a type, a requirement, and a throughput of the selected value-added service. The third set of attributes associated with the item may include at least one of a type, a size, a weight, one or more dimensions, and a shape of the item.

In some embodiments, the control server may be further configured to generate a notification indicative of at least one of the default lifecycle of the item, the modified lifecycle of the item, the detected value-added service requirement, the selected value-added service, and the allocation of the second set of resources to the selected value-added service, and transmit the notification to a user device of a user. The notification may have a timeout period associated therewith.

In some embodiments, the control server may be configured to modify the default lifecycle of the item further based on an acceptance signal received from the user device. The acceptance signal may be received in response to an acceptance of the notification at the user device within the timeout period.

In some embodiments, the control server may be configured to modify the default lifecycle of the item further based on a timeout signal. The timeout signal may be generated at expiry of the timeout period.

In some embodiments, the control server may be further configured to receive a feedback from the user device corresponding to the detected value-added service requirement based on the notification. The feedback may include at least one of a recommended value-added service and a set of recommended resources of the plurality of resources corresponding to the recommended value-added service. The control server may select the value-added service further based on the received feedback.

In some embodiments, the selected value-added service may be associated with a priority level such that the second set of resources capable of executing the selected value-added service is identified based on the priority level of the selected value-added service.

In some embodiments, the control server may be further configured to transmit one or more commands to the first set of resources to cause the first set of resources to execute the corresponding one or more predefined processes.

In some embodiments, the control server may be further configured to transmit one or more commands to the second set of resources to cause the second set of resources to execute the selected value-added service.

In some embodiments, the selected value-added service may have a first throughput, a first predefined process of the one or more predefined processes that immediately precedes the selected value-added service in the modified lifecycle may have a second throughput, and a second predefined process of the one or more predefined processes that immediately succeeds the selected value-added service in the modified lifecycle may have a third throughput.

In some embodiments, the control server may allocate the second set of resources to execute the selected value-added service such that second set of resources executes the selected value-added service while preserving the first throughput, the second throughput, and the third throughput.

In some embodiments, the control server may be further configured to determine an additional resource requirement for at least one of the first predefined process and the second predefined process due to the introduction of the selected value-added service, identify a third set of resources of the plurality of resources capable of executing the first predefined process or the second predefined process, and allocate the identified third set of resources to execute the first predefined process or the second predefined process such that the third set of resources execute the first predefined process or the second predefined process while preserving the first throughput, the second throughput, and the third throughput.

In some embodiments, the control server may be further configured to receive the identifier associated with the item from at least one identification device.

In some embodiments, the control server may be further configured to detect the requirement for the value-added service based on data received from at least one of the identification device or a user device.

In some embodiments, the control server may be further configured to match the detected value-added service requirement with one or more historical value-added service requirements included in the historical data, define a new value-added service for the detected value-added service requirement when the detected value-added service requirement is mismatched with the one or more historical value-added service requirements, and store therein, the detected value-added service requirement and the defined new value-added service.

Embodiments of the present disclosure provide a method for enablement of services and resource allocation in a storage facility. The method includes reception of an identifier associated with an item by a control server. A default lifecycle of the item is identified by the control server from historical data associated with the item, based on the received identifier. The default lifecycle may include one or more predefined processes. A first set of resources, a from a plurality of resources associated with the storage facility, is allocated by the control server to each of the one or more predefined processes for execution of the one or more predefined processes. A value-added service requirement during the execution of at least one of the one or more predefined processes is detected, in real-time, by the control server. A value-added service is selected by the control server from one or more value-added services included in the historical data, based on the detected value-added service requirement. The default lifecycle of the item is modified by the control server by introducing the selected value-added service subsequent to at least one of the one or more predefined processes. A second set of resources from the plurality of resources is identified by the control server based on at least one of a first set of attributes associated with each resource of the second set of resources, a second set of attributes associated with the selected value-added service, and a third set of attributes associated with the item. The second set of resources is identified to execute the selected value-added service. The identified second set of resources is allocated to the selected value-added service by the control server.

### BRIEF DESCRIPTION OF THE DRAWINGS

The accompanying drawings illustrate the various embodiments of systems, methods, and other aspects of the disclosure. It will be apparent to a person skilled in the art that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa.

Various embodiments of the present disclosure are illustrated by way of example, and not limited by the appended figures, in which like references indicate similar elements:

FIG. 1A is a block diagram that illustrates a system for enablement of services and resource allocation in a storage facility, in accordance with an exemplary embodiment of the present disclosure;

FIG. 1B is a block diagram that illustrates an exemplary environment of a storage facility, in accordance with an exemplary embodiment of the disclosure;

FIG. 2 is a block diagram that illustrates a control server, in accordance with an exemplary embodiment of the present disclosure;

FIG. 3A is a block diagram that illustrates an administrator dashboard of a Resource Management (RM) application, in accordance with an exemplary embodiment of the present disclosure;

FIG. 3B is a block diagram that illustrates an exemplary scenario of service enablement and resource allocation using the system, in accordance to the embodiments of the present disclosure; and

FIG. 4 represents a flow chart that illustrates a method (i.e., a process) for service enablement and resource allocation in the storage facility of FIG. 1B, in accordance with an exemplary embodiment of the disclosure.

Further areas of applicability of the present disclosure will become apparent from the detailed description provided hereinafter. It should be understood that the detailed description of exemplary embodiments is intended for illustration purposes only and is, therefore, not intended to necessarily limit the scope of the disclosure.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. In one example, the teachings presented and the needs of a particular application may yield multiple alternate and suitable approaches to implement the functionality of any detail described herein. Therefore, any approach may extend beyond the particular implementation choices in the following embodiments that are described and shown.

References to “an embodiment”, “another embodiment”, “yet another embodiment”, “one example”, “another example”, “yet another example”, “for example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

The system and method of the present disclosure provide a solution for efficiently handling items and/or activities in a storage facility. The disclosed system and method allow for introducing value-added services based on detection of value-added service requirements associated with an item and/or an activity. The system and method disclosed herein allow for dynamic resource allocation and management based on dynamic requirements within the storage facility. The system and method disclosed herein further allocates resources based on priority associated with each value-added service which improves throughput of the storage facility.

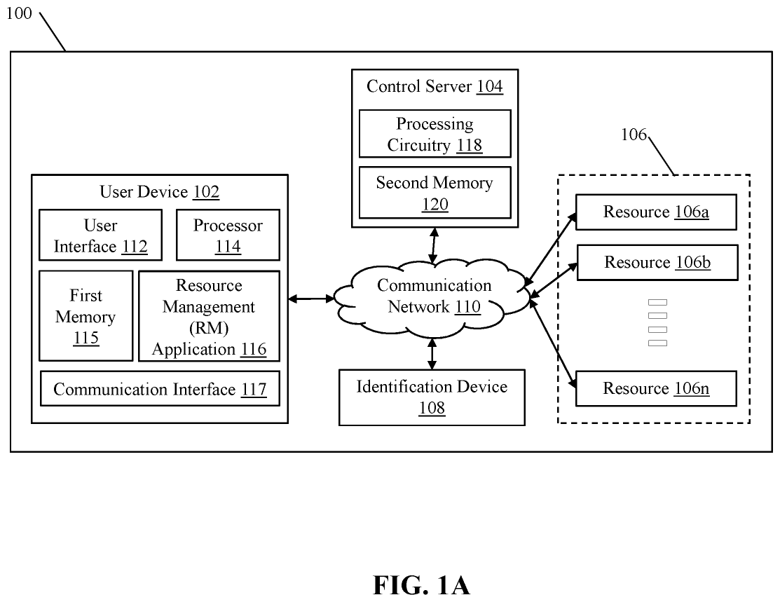

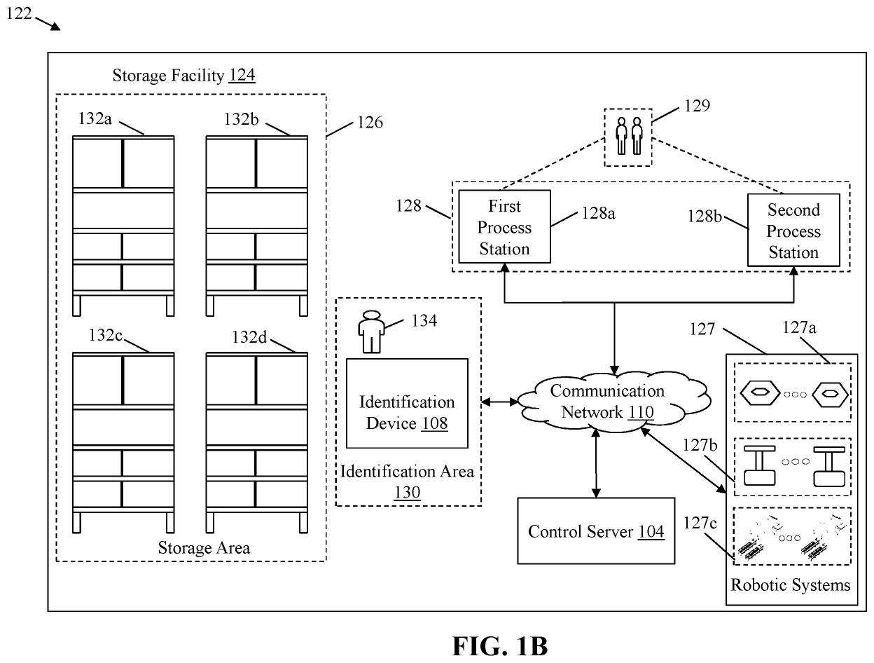

FIG. 1A is a block diagram that illustrates a system 100 for enablement of services and resource allocation in a storage facility, in accordance with an exemplary embodiment of the present disclosure. The system 100 may be configured to facilitate different value-added services required in the storage facility (for example, storage of items, retrieval of items, audit of items, quality control (QC) of items, during manufacturing of items, or the like) for each item and/or activity in the storage facility. The system 100 may include a user device 102, a control server 104, a plurality of resources 106a-106n (hereinafter, the plurality of resources 106a-106n are collectively referred to and designated as “the resources 106”), and an identification device 108. In an embodiment (as illustrated in FIG. 1A), the user device 102, the control server 104, the resources 106, and the identification device 108 may be communicatively coupled to each other via a communication network 110. In other embodiments, the user device 102, the control server 104, the resources 106, and the identification device 108 may be communicably coupled through separate communication networks established therebetween.

The user device 102 may include suitable logic, circuitry, interfaces, and/or code, executed by the circuitry, to facilitate a user to input data, receive data, and/or transmit data within the system 100. In some embodiments, the user may be an operator, an administrator, a manager, and/or the like in the storage facility. It will be apparent to a person of ordinary skill in the art that the user may be any personnel associated with the storage facility without deviating from the scope of the disclosure. Examples of the user device 102 may include, but are not limited to, a desktop, a notebook, a laptop, a handheld computer, a touch sensitive device, a computing device, a smart-phone, and/or a smartwatch. It will be apparent to a person of ordinary skill in the art that the user device 102 may include any device/apparatus that is capable of manipulation by the user without deviating from the scope of the disclosure. The user device 102 may include a user interface 112 and a processor 114.

The user interface 112 may correspond to an interface of the user device 102 using which the user interacts (e.g., provides inputs or perceives information) with the user device 102. The user interface 112 may include an input interface for receiving inputs from the user. Examples of the input interface may include, but are not limited to, a touch-based graphical user interface, a mouse, a keyboard, a motion recognition unit, a gesture recognition unit, a voice recognition unit, a light pen, an appearance of a desktop, or the like. The user interface 112 may further include an output interface for displaying (or presenting) an output to the user. Examples of the output interface may include, but are not limited to, a display device, a printer, a projection device, and/or a speaker. Embodiments of the present disclosure are intended to include or otherwise cover any type of input and output interfaces including known, related art, and/or later developed technologies.

The processor 114 may include suitable logic, instructions, circuitry, interfaces, and/or code for executing various operations, such as the operations associated with the user device 102, or the like. The processor 114 may be configured to control one or more operations executed by the user device 102 in response to the input received at the user device 102 from the user and/or commands received from the control server 104. Examples of the processor 114 may include, but are not limited to, an application-specific integrated circuit (ASIC) processor, a reduced instruction set computing (RISC) processor, a complex instruction set computing (CISC) processor, a field-programmable gate array (FPGA), a Programmable Logic Control unit (PLC), and the like.

The user device 102 may further include a first memory 115 configured to store the logic, instructions, and/or code executable by the processor 114, data associated with the user device 102, and data associated with the system 100. Examples of the first memory 115 may include, but are not limited to, a Read-Only Memory (ROM), a Random Access Memory (RAM), a flash memory, a removable storage drive, a hard disk drive (HDD), a solid-state memory, a magnetic storage drive, a Programmable Read Only Memory (PROM), an Erasable PROM (EPROM), and/or an Electrically EPROM (EEPROM).

The user device 102 may further include computer executable applications configured to be executed by the processor 114. The computer executable applications may include suitable logic, instructions, and/or code for executing various operations. The computer executable applications may be stored in the first memory 115. Examples of the computer executable applications may include, but are not limited to, audio applications, video applications, social media applications, navigation applications, Resource Management (RM) applications, and/or the like. The computer executable applications, as shown in FIG. 1A, may include an RM application 116. One or more operations associated with the RM application 116 may be controlled by the control server 104.

The user device 102 may further include a communication interface 117. The communication interface 117 may be configured to enable the user device 102 to communicate with the control server 104 and other components of the system 100 over the communication network 110. Examples of the communication interface 117 may include, but are not limited to, a modem, a network interface such as an Ethernet card, a communication port, and/or a Personal Computer Memory Card International Association (PCMCIA) slot and card, an antenna, a radio frequency (RF) transceiver, one or more amplifiers, a tuner, one or more oscillators, a digital signal processor, a coder-decoder (CODEC) chipset, a subscriber identity module (SIM) card, and a local buffer circuit. It will be apparent to a person of ordinary skill in the art that the communication interface 117 may include any device and/or apparatus capable of providing wireless or wired communications between the user device 102 and the control server 104.

The control server 104 may be a network of computers, a software framework, or a combination thereof, that may provide a generalized approach to create the server implementation. Examples of the control server 104 may include, but are not limited to, personal computers, laptops, mini-computers, mainframe computers, any non-transient and tangible machine that can execute a machine-readable code, cloud-based servers, distributed server networks, or a network of computer systems. The control server 104 may be realized through various web-based technologies such as, but not limited to, a Java web-framework, a .NET framework, a personal home page (PHP) framework, or any web-application framework. The control server 104 may be maintained by a storage facility management authority or a third-party entity that facilitates service enablement and resource allocation operations of the system 100. The control server 104 may be part of an automated warehouse management system (WMS), which may be a standalone system. Alternatively, the control server 104 may be integrated with the automated WMS. In certain embodiments, the control server 104 may be integrated with supply chain systems and/or integrated enterprise resource planning (ERP) systems. It will be apparent to a person of ordinary skill in the art that the control server 104 may perform various service enablement operations, resource allocation operations, inventory management operations, or the like. The control server 104 may include processing circuitry 118 and one or more second memories, for example, a second memory 120.

The processing circuitry 118 may include suitable logic, instructions, circuitry, interfaces, and/or code for executing various operations, such as resource management operations, resource allocation operations, service enablement operations, service requirement detection operations, or the like. Examples of the value-added service requirements may include, but are not limited to, load distribution requirements, resolving an anomaly or discrepancy with an item and/or an activity, forecasting a new service, an emergency in the storage facility, item fallen during transportation or transformation, correcting damaged markers, or the like. An example of a forecasted service may include on-the-go charging of a resource (e.g., any of the resource 106) when a battery level of the resource is forecasted to fall below a threshold while executing a process or operation. Another example of a forecasted service may include creating a new workstation (for example, order consolidation station, pick-put station, packaging station, ad-hoc service station, or the like) based on anticipated workload and operational capacities of current workstations. It will apparent to a person of ordinary skill in the art that the abovementioned examples should not be construed to limit the scope of the disclosure. Forecasted services may cater to any type of service requirements that can originate in a storage facility.

The processing circuitry 118 may be configured to host and enable the RM application 116 running on (or installed on) the user device 102 to execute the operations associated with the system 100 by communicating commands and/or instructions over the communication network 110. Examples of the processing circuitry 118 may include, but are not limited to, an ASIC processor, a RISC processor, a CISC processor, a FPGA, and the like.

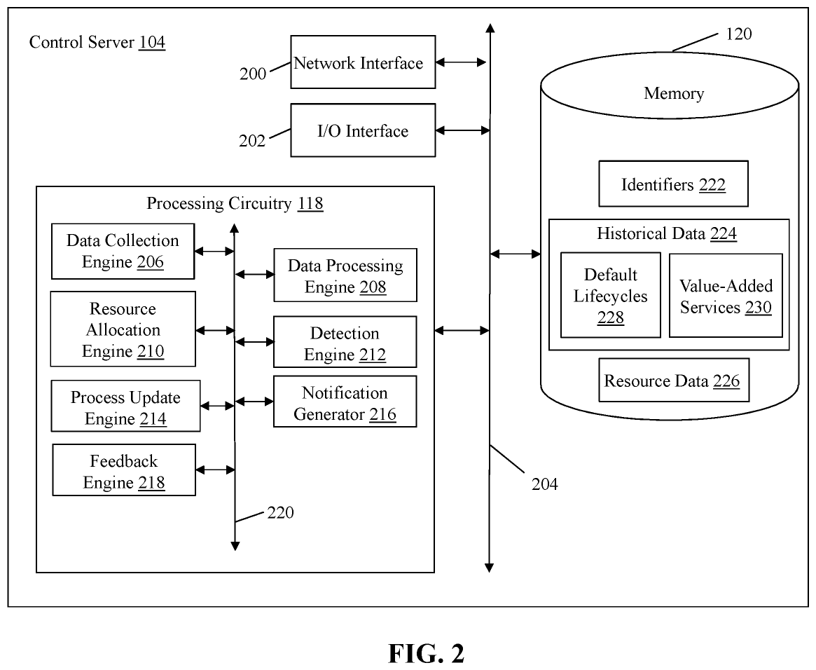

The processing circuitry 118 may be configured to perform various service enablement or resource allocation operations of the system 100. Examples of the service enablement or resource allocation operations may include, but are not limited to, storing historical data of various items and/or activities in the storage facility, receiving an identifier associated with an item and/or an activity, identifying a default lifecycle of the item and/or the activity based on the received identifier, and allocating a first set of resources from the resources 106 to each predefined process included in the default lifecycle of the item and/or activity for execution of the predefined process. Examples of the service enablement or resource allocation operations may further include, but are not limited to, detecting a value-added service requirement during execution of a predefined process of the default lifecycle of the item and/or the activity, selecting a value-added service based on the detected value-added service requirement, and modifying the default lifecycle of the item and/or the activity by introducing the selected value-added service in the default lifecycle. Examples of the service enablement or resource allocation operations may further include, but are not limited to, identifying a second set of resources from the resources 106 to execute the selected value-added service and allocating the identified second set of resources to the selected value-added service. For processing the service enablement or resource allocation operations, the processing circuitry 118 may be further configured to control the resources 106 and perform one or more operations as described in the foregoing descriptions of FIG. 2.

The second memory 120 may be configured to store various logic, instructions, interfaces, and/or code executable by the processing circuitry 118 for implementing various operations. The second memory 120 may be further configured to store therein, a plurality of identifiers and historical data of various items and/or activities that are associated with the storage facility. The historical data of an item or an activity may include a default lifecycle of the item and/or the activity and various value-added services historically executed with respect to the item and/or the activity. The historical data of the item and/or the activity may further include various attributes and/or parameters associated with the item or the activity. The attributes of an item may include, but are not limited to, a type of the item, a weight of the item, one or more dimensions of the item, a shape of the item, a size of the item, a color of the item, a material of the item, or the like. The attributes of an activity may include, but are not limited to, a type of the activity, a priority level of the activity, a time-period associated with the activity, or the like.

Examples of the second memory 120 may include but are not limited to, a ROM, a RAM, a flash memory, a removable storage drive, a HDD, a solid-state memory, a magnetic storage drive, a PROM, an EPROM, and/or an EEPROM. In some embodiments, a set of centralized or distributed network of peripheral memory devices may be interfaced with the control server 104, as an example, on a cloud server.

The resources 106 may include suitable logic, instructions, circuitry, interfaces, and/or code, executable by the circuitry, that may be configured to execute various operations associated with the system 100 based on various commands and/or instructions received from the control server 104. The resources 106 may be utilized to implement various dynamic processes and service enablement operations in the storage facility. For example, those resources 106 that are assigned to a transportation process may move across one or more locations in the storage facility to execute the transportation process based on the commands received from the control server 104. The resources 106 may include various types of robotic apparatus that are capable of executing various operations (e.g., a transportation process for an item, a transformation process corresponding to an item, or the like) and other peripheral tasks in the storage facility (as shown in FIG. 1B). Various types of robotic apparatus may include, but are not limited to, autonomous mobile robots (AMRs), autonomous guided vehicles (AGVs), robotic manipulators with different types of end effectors, robotic apparatus with conveying mechanism, or the like. The resources 106 may further include various systems, apparatus, devices, or the like in the storage facility that enable various operations in the storage facility. For example, the resources 106 may further include sorting mechanisms, movable storage systems, charging stations, elevators, and workstations (e.g., order consolidation stations, pick-put stations, operator stations, or the like). The resources 106 may include various sensors (e.g., image sensors, RFID sensors, and/or the like) for determining a relative position thereof in the storage facility, or the like.

The resources 106 may have different attributes such as shapes, sizes, dimensions, configurations, load capacity, operational capabilities, or the like. Operational capabilities of a resource may be indicative of various processes, services, or tasks that the resource is capable of performing. For example, a robotic apparatus with forceps-based end effectors may not be capable of handling deformable items, thus, the operational capabilities of such robotic apparatus may indicate “not suitable for deformable item”. Similarly, a robotic apparatus with spatula-shaped end effectors may be capable of handling deformable items, thus, the operational capabilities of such robotic apparatus may indicate “suitable for deformable items”. Load capacity of a resource may indicate a maximum limit of load the resource is capable of handling. It will be apparent to a person of ordinary skill in the art that the scope of the resources 106 is not limited to include robotic systems, physical systems, or the like. The resources 106 may include human operators as well.

The identification device 108 may include suitable circuitry that may be configured to capture identification data associated with an item and/or an activity in the storage facility. For example, the identification device 108 may be configured to capture an image and/or a video, scan a code or a machine-readable optical label, or the like. Further, the identification device 108 may be configured to transmit the captured data to the control server 104, which may be configured to extract an identifier associated with the item and/or the activity from the captured data. In one embodiment, the identification device 108 may be installed at a sorting station (not shown) configured to receive a plurality of items for stock keeping unit (SKU) profiling. In another embodiment, the identification device 108 may be installed across the storage facility to automatically capture the data associated with the item and/or activity in real time. Examples of the identification device 108 may include, but are not limited to, an imaging device, a scanning device, a sensing device, an audio capturing device, a radio-frequency identification (RFID) receiver, a biometric device, and/or the like.

The communication network 110 may include suitable logic, circuitry, and interfaces that may be configured to provide a plurality of network ports and a plurality of communication channels for transmission and reception of data related to operations of various entities (such as the user device 102, the control server 104, the resources 106, and/or the identification device 108) of the system 100. Each network port may correspond to a virtual address (or a physical machine address) for transmission and reception of the communication data. For example, the virtual address may be an Internet Protocol Version 4 (IPV4) (or an IPV6 address) and the physical address may be a Media Access Control (MAC) address. The communication network 110 may be associated with an application layer for implementation of communication protocols based on one or more communication requests from the user device 102, the control server 104, the resources 106, and/or the identification device 108. The communication data may be transmitted or received, via the communication protocols. Examples of the communication protocols may include, but are not limited to, Hypertext Transfer Protocol (HTTP), File Transfer Protocol (FTP), Simple Mail Transfer Protocol (SMTP), Domain Network System (DNS) protocol, Common Management Interface Protocol (CMIP), Transmission Control Protocol and Internet Protocol (TCP/IP), User Datagram Protocol (UDP), Long Term Evolution (LTE) communication protocols, or any combination thereof.

In one embodiment, the communication data may be transmitted or received via at least one communication channel of a plurality of communication channels in the communication network 110. The communication channels may include, but are not limited to, a wireless channel, a wired channel, a combination of wireless and wired channel thereof. The wireless or wired channel may be associated with a data standard which may be defined by one of a Local Area Network (LAN), a Personal Area Network (PAN), a Wireless Local Area Network (WLAN), a Wireless Sensor Network (WSN), Wireless Area Network (WAN), Wireless Wide Area Network (WWAN), a metropolitan area network (MAN), a satellite network, the Internet, a fiber optic network, a coaxial cable network, an infrared (IR) network, a radio frequency (RF) network, and a combination thereof. Embodiments of the present invention are intended to include or otherwise cover any type of communication channel, including known, related art, and/or later developed technologies.

FIG. 1B is a block diagram that illustrates an exemplary environment 122 of a storage facility 124, in accordance with an exemplary embodiment of the disclosure. The storage facility 124 may include a storage area 126, a plurality of robotic systems 127, a plurality of process stations of which first and second process stations 128a and128b are shown (hereinafter, collectively referred to and designated as “the process stations 128”), a plurality of users 129, an identification area 130, and the control server 104. The plurality of robotic systems 127, the process stations 128, and the plurality of users 129 may correspond to the resources 106 (as shown in FIG. 1A) of the storage facility 124. The control server 104 may communicate with the plurality of robotic systems 127 and the process stations 128 by way of the communication network 110 or through separate communication networks established therebetween.

The storage facility 124 may store multiple inventory items for fulfillment of one or more orders, maintenance of inventory stock, and/or selling of one or more inventory items. Examples of the storage facility 124 may include, but are not limited to, a forward storage facility, a backward storage facility, a fulfillment center, a manufacturing center, or a retail store (e.g., a supermarket, an apparel store, or the like). The inventory items are stored in the storage area 126. Examples of the inventory items may include, but are not limited to, groceries, apparel, electronics, or the like. The storage area 126 may be of any shape, for example, a rectangular shape. The storage area 126 may include a plurality of storage systems (of which first through fourth storage systems 132a-132d are shown) that are arranged within the storage area 126. Arrangement of the plurality of storage systems in the storage area 126 may be performed in any desired configuration known to those of skill in the art. For example, the plurality of storage systems may be arranged in rows and columns in a way that they form aisles therebetween. Hereinafter, the plurality of storage systems is collectively referred to and designated as “the plurality of storage systems 132a-132d”. In an embodiment, the resources 106 may further include the plurality of storage systems 132a-132d.

The plurality of storage systems 132a-132d may be physical storage units, where each storage system may include a plurality of shelves. In an embodiment, each shelf may include various bins/totes placed at different spatial positions to accommodate (or store) various inventory items. Examples of the plurality of storage systems 132a-132d may include, but are not limited to, multi-tier racks, pallet racks, shelves, mobile shelves, mezzanine floors, vertical lift modules, horizontal carousels, conveyors, and vertical carousels. In one embodiment, the plurality of storage systems 132a-132d may have different shapes, sizes, and dimensions. Hereinafter, the terms ‘inventory items’ and ‘items’ are used interchangeably. In one embodiment, the plurality of storage systems 132a-132d are mobile storage systems that are movable from one location to another within the storage facility 124. In such implementation, the movement of the plurality of storage systems 132a-132d may be enabled by the robotic systems 127.

Each of the plurality of storage systems 132a-132d may further include a reference marker associated therewith for uniquely identifying the corresponding storage system. Examples of the reference marker may include, but are not limited to, a barcode, a quick response (QR) code, a radio frequency identification device (RFID) tag, or the like. It will be apparent to those of skill in the art that the plurality of storage systems 132a-132d may further include additional structural features that aid in movement of the plurality of storage systems 132a-132d within the storage facility 124, without deviating from the scope of the disclosure.

The plurality of robotic systems 127 may be configured to perform various operations (e.g., a transportation process for the inventory items stored in the storage area 126, a transformation process corresponding to the inventory items stored in the storage area 126, or the like) under the control of the control server 104. The plurality of robotic systems 127 may be configured to transport the inventory items and/or the plurality of storage systems 132a-132d between the storage area 126 and the process stations 128 and the identification area 130. For example, an inventory item stored in the storage area 126 may need to be transported to one of the process stations 128. In such a scenario, one of the plurality of robotic systems 127, in response to instructions received from the control server 104, may execute the transportation process for the inventory item. The plurality of robotic systems 127 may be further configured to transform the inventory items as per the requirement. For example, a packing of containing 30 units first item may need to be broken obtain 5 units of the first item. In such a scenario, a robotic system of the plurality of robotic systems 127, in response to instructions received from the control server 104, may break the packing to obtain 5 units of the first item, here, the braking of the packing may correspond to a transformation process. In another example, an apparel item might need ironing. In such a scenario, a robotic system of the plurality of robotic systems 127, in response to instructions received from the control server 104, may iron the apparel, here, ironing the apparel may correspond to another transformation process. In other words, a transformation process may refer to a process in which a state of an item is changed and a transportation process refers to a process in which a location of the item is changed. The plurality of robotic systems 127 may include various types of robotic systems, for example a first type of robotic systems127a, a second type of robotic systems 127b, and a third type of robotic systems 127c.

The first type of robotic systems 127a are autonomous mobile robots (AMRs) or autonomous guided vehicles (AGVs) that are configured to transport the inventory items or the plurality of storage systems 132a-132d from one location to another location in the storage facility. The first type of robotic systems 127a may include different functional components, such as a lifting mechanism, an adaptive payload management system, and an autonomous guidance system, by use of which a payload (e.g., a storage system or an inventory palette) may be moved through different locations in the storage facility 124. The first type of robotic systems 127a may be equipped with suitable components to enable a multi-floor transfer of goods. for example, one of the robotic systems 127a may move within different floors and fulfil the requirements of the control server 104 by picking different storage systems 132a-132d from one floor and transferring it to the process stations 128. In addition, the first type of robotic systems 127a may be configured to adapt to different functional parameters, e.g., payload weight, transfer path, cycle time, or the like, in accordance with seamlessly changing of inventory profiles, demand patterns, and order peaks. The first type of robotic systems 127a may be functionally same or different from each other, with possible variations in payload capacity (in pounds (lbs) or kilograms (Kgs)).

The second type of robotic systems 127b are robotic apparatus with one or more conveying mechanisms that enable the second type of robotic systems 127b to receive and transfer items without manual intervention. The second type of robotic systems 127 are capable of moving from one location to another for executing various operations.

The third type of robotic systems 127c are robotic manipulators that may be configured to execute different operations, such as, pick, hold, grab, transfer, sort, put away, or reverse put inventory items from and/or to the storage systems 132a-132d. The third type of robotic systems 127c may have one or more robotic arms coupled to one or more end effectors. An end effector may be a grabbing or a holding tool detachably attached or affixed to a robotic arm of a robotic system of the third type of robotic systems 127c. Each robotic arm may include different functional portions (e.g., arms), movement of which may be maneuvered by a plurality of actuators to guide the corresponding end effectors to a particular inventory item. The movement of each robotic arm in a 3D space may be restricted by a defined number of degrees of freedom exhibited by different functional portions of the corresponding robotic arm. Different functional portions may be maneuvered based on machine instructions received from the control server 104 based on optimal position parameters of different inventory items relative to a position (i.e., an origin) of the third type of robotic systems 127c.

Although FIG. 1B only shows three types of robotic systems, the scope of the disclosure may be expanded to include other types of known robotic systems. For example, the plurality of robotic systems 127 may further include one or more portable charging robots. The portable charging robots may be deployed in the storage facility 124 and may be configured to provide on the go charging facilities to other electrically operated resources of the resources 106.

The process stations 128 may refer to workstations in the storage facility 124 where one or more processes or value-added services are executed by the plurality of robotic systems 127 and/or the plurality of users 129. The process stations 128 may be assigned with predefined processes or value-added service by the control server 104. The process stations 128 may include order consolidation stations, pick-put stations, packaging stations, sorting station, value-added service stations, peripheral task stations, or the like. Each of the process stations 128 may include a user device (e.g., the user device 102) that receives various commands or instructions from the control server 104. Based on the received commands or instructions, the robotic systems 127 or the plurality of users 129 assigned to the process stations 128 may execute the required operations (e.g., predefined process or a value-added service). For example, an item retrieval process at a pick-put process station (e.g., the process station 128) may involve retrieval of one or more inventory item from a storage system (e.g., any of the storage systems 132) and placing the picked inventory item in one or more bins, totes, boxes, or on any of the second type of robotic systems 127b waiting at the process station for item collection. In other words, the process stations 128 are workstations where different types of transformation processes are executed on the inventory items. It will be apparent to those of skill in the art that the predefined processes may further include any type of process associated with the inventory item, without deviating from the scope of the disclosure.

The storage facility 124 may further include a dedicated area, e.g., the identification area 130, for identification of various items in the storage facility 124. The identification area 130 may include the identification device 108 as discussed in conjunction with FIG. 1A. Depending upon a capacity of the identification area 130, a fixed count of items may be received at the identification area 130 at a given time and identification data associated with the received items may be captured through the identification device 108. In some embodiment, a dedicated operator 134 (human or robotic) may be allocated to the identification area 130 for inspecting and overseeing various operations being performed in the identification area 130.

The storage facility 124 may further include a plurality of sensors such as image sensors, radio-frequency identification (RFID) sensors, and/or the like, installed at different locations within the storage facility 124. Each of the sensors may be communicably coupled to the control server 104 via the communication network 110. In an embodiment, the sensors may be mounted on walls of the storage facility 124. In other embodiment, the sensors may be mounted on the plurality of storage systems 132a-132d, the process stations 128, and the plurality of robotic systems 127. In an embodiment, the sensors may periodically communicate data to the control server 104. In another embodiment, the sensors may be configured to transmit the data upon being prompted by the control server 104. In another embodiment, the sensors may be configured to transmit the data upon detecting a movement associated with one or more items, the resources 106, or any other object in the storage facility 124. In an embodiment, each of the sensors may be configured to track the items and the resources 106 in order to capture movement of the items during process execution.

In operation, the system 100 may be configured to facilitate enablement of services and resource allocation in the storage facility 124. The resources 106 may be configured to execute various operations based on commands and/or instructions received from the control server 104. The control server 104 may be configured to store therein the plurality of identifiers (as shown in FIG. 2) and the historical data (as shown in FIG. 2) of the items and/or the activities associated with the storage facility 124. The control server 104 may receive an order request indicating an identifier of a required item, an activity request indicating an identifier of a required activity, or data captured by the identification device 108. The control server 104 may be configured to identify, from the historical data, a default lifecycle of the item and/or the activity indicated by the received identifier. The default lifecycle of the item and/or activity may include one or more predefined processes that define various routine stages that the item or the activity has to undergo for fulfill a corresponding operation (e.g., order fulfilment, replenishment of inventory, restocking an item, charging a resource, or the like) in the storage facility 124. Each predefined process may be a transportation process or a transformation process. In one exemplary scenario, the predefined processes in the default lifecycle of the item may be executed in a sequential manner (for example, one after the other). In another exemplary scenario, two or more predefined processes of the predefined processes may be executed in parallel followed by subsequent predefined processes in the default lifecycle.

For example, a default lifecycle for storing a new inventory item in the storage facility may include transporting the item to a labelling station, labelling the item with a new reference marker at the labelling station, transporting the labelled item to a pick-put process station, placing the item in a storage system waiting at the pick-put station to receive the item, and transporting the storage system with the item to a dedicated location in the storage area 126. In another example, a default lifecycle of an item for order consolidation may include transporting the storage system with the required item to a pick-put process station, retrieving the item from the storage system, and placing the item in an order bin and/or tote.

The control server 104 may be configured to allocate a first set of resources from the resources 106 to each predefined process of the default lifecycle for execution of the predefined processes. For example, the control server 104 may allocate one of the robotic systems 127 to transport one of the storage systems 132a-132d storing the requisite item and one of the process stations 128 to execute a pick-put operation on the item. Based on the allocation and the instructions of the control server 104, the first set of resources of the resources 106 may be configured to execute the corresponding predefined process of the default lifecycle.

The control server 104 may be configured to monitor a real-time execution of each predefined process by the corresponding first set of resources. Based on the monitoring, the control server 104 may be configured to detect, in real time, a value-added service requirement during the execution of one of the predefined processes. A value-added service requirement may refer to any dynamic requirement associated with an item or one or more resources executing a predefined process on the item that may prevent a successful completion of the default lifecycle. For example, while transporting a storage system to one of the process stations 128, if a battery level of a corresponding robotic system 127 falls below a threshold value, the transportation process may not be completed. In such a scenario, on-the-go charging of the robotic system 127 or re-allocation of the transporting process to another robotic system 127 may be required.

The control server 104 may be configured to select, from the value-added services associated with the item and/or the activity stored in the second memory 120, a value-added service based on the detected value-added service requirement. The control server 104 may be further configured to modify the default lifecycle of the item and/or the activity by introducing the selected value-added service subsequent to one of the predefined processes. The control server 104 may be configured to identify a second set of resources from the resources 106 to execute the selected value-added service, based on a first set of attributes associated with each resource of the second set of resources, a second set of attributes associated with the selected value-added service, and a third set of attributes associated with the item. In one embodiment, the second set of resources may be different from the first set of resources. In another embodiment, the second set of resources may include one or more resources from the first set of resources. The control server 104 may be further configured to allocate the identified second set of resources to the selected value-added service for execution of the value-added service. In an exemplary scenario, the selected value-added service may have a first throughput, a predefined process that immediately precedes the selected value-added service in the modified lifecycle may have a second throughput, and a predefined process that immediately succeeds the selected value-added service in the modified lifecycle may have a third throughput. In such a scenario, the control server 104 may be configured to allocate the second set of resources from the resources 106 to execute the selected value-added service such that second set of resources executes the selected value-added service while preserving the first throughput, the second throughput, and the third throughput.

In one embodiment, the control server 104 may be further configured to generate a notification indicative of the default lifecycle of the item and/or the activity, the modified lifecycle of the item and/or the activity, the detected value-added service requirement, the selected value-added service, and/or the allocation of the second set of resources to the selected value-added service. The notification may be associated with a timeout period. The control server 104 may be further configured to transmit the notification to the user device 102. The control server 104 may modify the default lifecycle of the item and/or the activity further based on an acceptance signal or a feedback received from the user device 102. In a scenario, where the acceptance signal or the feedback is not received before the expiry of the timeout period, the control server 104 may automatically modify the default lifecycle of the item and/or the activity and generate a timeout signal at expiry of the timeout period. In other words, the control server 104 may be configured to generate the timeout signal at the expiry of the timeout period, when no acceptance signal or feedback is received within the timeout period. Similarly, the control server 104 may be configured to detect various value-added service requirements in the complete lifecycle of the item and/or the activity and manage dynamic resource allocation for new value-added services without compromising on desired throughputs.

FIG. 2 is a block diagram that illustrates the control server 104, in accordance with an exemplary embodiment of the present disclosure. The control server 104 may include the processing circuitry 118 and the second memory 120. The control server 104 may further include a network interface 200 and an input/output (I/O) interface 202. The processing circuitry 118, the second memory 120, the network interface 200, and the input/output (I/O) interface 202 may communicate with each other by way of a first communication bus 204. The processing circuitry 118 may include a data collection engine 206, a data processing engine 208, a resource allocation engine 210, a detection engine 212, a process update engine 214, a notification generator 216, and a feedback engine 218 that communicate with each other by way of a second communication bus 220. It will be apparent to a person having ordinary skill in the art that the control server 104 is for illustrative purposes and not limited to any specific combination of hardware circuitry and/or software.

The second memory 120 may be configured to store the plurality of identifiers 222 (hereinafter, interchangeably referred to as “the identifiers 222”) of the plurality of items and/or activities associated with the storage facility 124. The identifiers 222 may include identification data associated with the plurality of items and/or activities. In some embodiments, the identifiers 222 may include Stock Keeping Units (SKUs). An SKU for an item may be a unique code that is physically readable, electronically readable, or both by the identification device 108 or one or more image sensors in the storage facility 124. For example, the SKU may be a bar code, a passive printable or attachable radio frequency (RF) tag, a quick response (QR) code, and/or the like. In one embodiment, the identifiers 222 may include predefined patterns.

The second memory 120 may be further configured to store the historical data 224 of the plurality of items and/or activities associated with the storage facility 124. The historical data 224 may include various actions, such as the plurality of default lifecycles 228 and the plurality of value-added services 230, executed for the plurality of items and/or activities in the past. Each default lifecycle of the plurality of default lifecycles 228 may include one or more predefined processes that may be executed by the resources 106 based on one or more commands received from the control server 104. Each predefined process may correspond to a transportation process, a transformation process, or a combination thereof In some embodiments, the user may provide inputs through the user device 102 for defining the plurality of default lifecycles 228. The processing circuitry 118 may be configured to define the plurality of default lifecycles 228 based on the inputs received from the user and/or the third set of attributes of the plurality of items and/or activities. In some embodiments, the processing circuitry 118 may be configured to utilize one or more machine learning algorithms and/or artificial intelligence algorithms to define the plurality of default lifecycles 228 for the plurality of items and/or activities.

Due to dynamically changing requirements in the storage facility 124 and one or more anomalies detected with respect to an item and/or an activity, a corresponding default lifecycle may need to be modified by introducing value-added services that caters to the dynamic requirements or the anomalies. The value-added services 230 include those services that were historically executed with respect to the item and/or the activity in response to detection of a value-added service requirement (e.g., dynamic requirements and the anomalies). Each value-added service 230 may include a set of predefined actions that may be required to be executed in response to a detection of a value-added service requirement. For example, a default lifecycle for restocking a returned inventory item, such as an apparel, into the storage systems 132a-132d of the storage area 126 (as shown in FIG. 1B) may include a set of predefined processes to be executed on the inventory item. Examples of the set of predefined processes may include various transformation and transportation processes associated with the apparel. Examples of the transformation processes may include, but are not limited to, folding and packaging, and transportation processes may include transporting from one process station to another for executing the transformation processes. However, if the control server 104 detects “wrinkles in the apparel” during folding process, the control server 104 may interpret the “wrinkles in the apparel” scenario as a value-added service requirement. Further, upon detecting the value-added service requirement for the apparel, the control server 104 may be configured to select from the historical data, a value-added service (e.g., ironing or dry cleaning) corresponding to the value-added service requirement, e.g., “wrinkles in the apparel”.

In another exemplary scenario, during a packaging process of an apparel, if the control server 104 detects “a tag missing from the apparel”, the control server 104 may interpret “tag missing from the apparel” scenario as a value-added service requirement. Further, upon detecting the value-added service requirement for the apparel, the control server 104 may be configured to select from the historical data 224, the value-added service (for e.g., “attach a tag”) corresponding to the value-added service requirement, i.e., “a tag missing from the apparel”.

In another exemplary scenario, during a packaging process of an electronic item, if the control server 104 detects that the electronic item has fallen and has a broken panel, the control server 104 may be configured to interpret “fallen” and “broken panel” scenarios as a value-added service requirement. Further, upon detecting the value-added service requirement for the electronic item, the control server 104 may be configured to select from the historical data 224, the value-added service corresponding to the value-added service requirement, i.e., “fallen” and “broken panel”.

The second memory 120 may be further configured to store resource data 226. The resource data 226 may include various attributes associated with each of the resources 106 that may facilitate in selection and allocation of the resources 106 upon detection of a value-added service requirement by the control server 104. The first set of attributes of a resource may include a load capacity, dimensions, an expertise, a capability, a condition, a type, a charging capacity, a shape, a size, a configuration, an availability, a current location, a turnaround time, or the like. In an exemplary scenario, if the control server 104 determines that two resources that are capable of executing “ironing” of an apparel are currently available, the control server 104 may be configured to allocate “ironing” of the apparel to that resource for which the turnaround time is least. In another exemplary scenario, the control server 104 may determine that of all the available resources 106 only one resource is capable of executing “ironing” of an apparel. In such a scenario, the control server 104 may be configured to allocate “ironing” of the apparel to the resource that is available and capable of executing “ironing”. In another exemplary scenario, if the control server 104 determines that all resources that are capable to execute “ironing” of the apparel are currently allocated and unavailable, the control server 104 may be configured to put “ironing” of the apparel on hold until one of the resources capable to execute “ironing” becomes available. In another scenario, where a priority level of “ironing” is greater than ongoing processes or services, the control server 104 may be configured to instruct one of the resources capable of executing “ironing” to put the ongoing process or service on hold, and execute “ironing” of the apparel.

The control server 104 may be further configured to monitor in real-time the condition (e.g., a battery status, or the like), the availability, the current location, the turnaround time of the resources 106 to update the resource data 226.

The network interface 200 may include suitable logic, circuitry, and interfaces that may be configured to establish and enable a communication between the control server 104 and different components of the exemplary environment 122, via the communication network 110. The network interface 200 may be implemented by use of various known technologies to support wired or wireless communication of the control server 104 with the communication network 110. The network interface 200 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, and a local buffer circuit.

The I/O interface 202 may include suitable logic, circuitry, interfaces, and/or code that may be configured to receive inputs (e.g., orders) and transmit server outputs via a plurality of data ports in the control server 104. The I/O interface 202 may include various input and output data ports for different I/O devices. Examples of such I/O devices may include, but are not limited to, a touch screen, a keyboard, a mouse, a joystick, a projector audio output, a microphone, an image-capture device, a liquid crystal display (LCD) screen and/or a speaker.

The processing circuitry 118 may be configured to perform the service enablement and the resource allocation operations by way of the data collection engine 206, the data processing engine 208, the resource allocation engine 210, the detection engine 212, the process update engine 214, the notification generator 216, and the feedback engine 218.

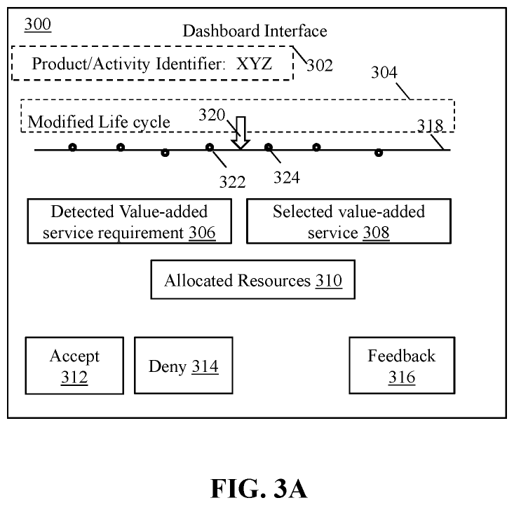

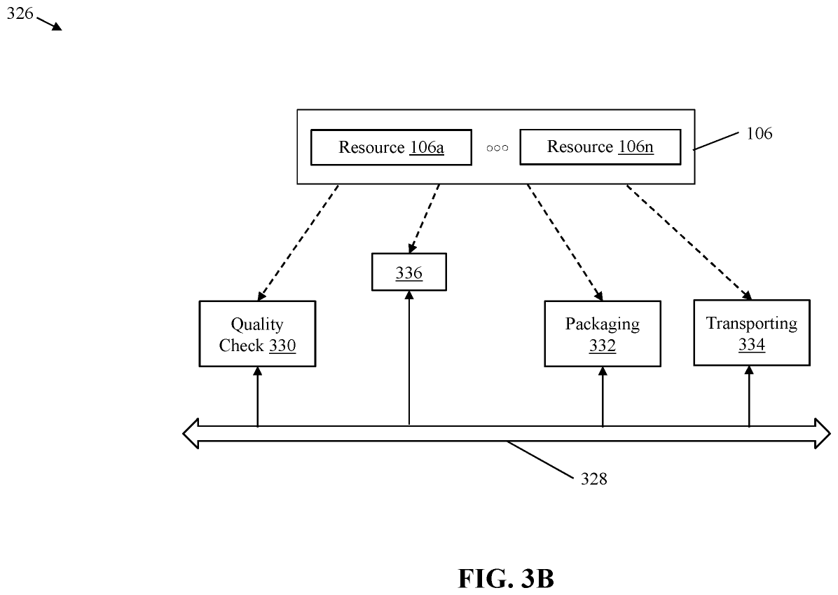

The data collection engine 206 may be configured to receive identification data associated with an item and/or an activity from the identification device 108 installed in the identification area 130 (as shown in FIG. 1B). In another embodiment, the the data collection engine 206 may be configured to receive the identification data from the identification device 108 installed in the storage facility 124 (as shown in FIG. 1B). In another embodiment, the data collection engine 206 may be configured to receive the identification data that may be manually entered by the user using an administrator dashboard (as shown in FIG. 3A) displayed through the user interface 112 of the user device 102. In another embodiment, the data collection engine 206 may be configured to receive identification data associated with an item and/or an activity in an order request. It will be apparent to those of skill in the art that that the scope of the disclosure is not limited to a single item and/or activity. The system and method of the disclosure can simultaneously process multiple items and/or activities without deviating from the scope of the disclosure.

In some embodiments, the identification data may include, but is not limited to, an identifier, one or more images, one or more videos, a set of attributes (as discussed above), or the like of the item and/or activity. Embodiments of the present disclosure are intended to include or otherwise cover any type of the identification data that may facilitate in identification of the item and/or the activity.

The data collection engine 206 may be further configured to transmit the received identification data to the data processing engine 208 through the second communication bus 220. The data collection engine 206 may be further configured to store the received identification data in the second memory 120.

The data processing engine 208 may be configured to receive the identification data from the data collection engine 206 and further process the received identification data to extract an identifier. In an embodiment, the data processing engine 208 may be configured to employ one or more image processing techniques to extract the identifier from the received identification data when the received identification data is an image and/or a video. The image processing techniques may include, but are not limited to, an anisotropic diffusion, a hidden Markov model, an image editing, an image restoration, an independent component analysis, a linear filtering, neural networks, partial differential equations, or the like. In another embodiment, the data processing engine 208 may be configured to employ voice recognition and other similar techniques to extract the identifier from the received identification data when the received identification data includes voice inputs from the user. The identifier may facilitate the data processing engine 208 to identify the item and/or the activity.

The data processing engine 208 may be further configured to compare the identifier received in the identification data with the identifiers 222 stored in the second memory 120. In an embodiment, the data processing engine 208 may determine that the identifier received in the identification data matches at least one of the identifiers 222 stored in the second memory 120. The data processing engine 208 may be configured to generate a match signal when the data processing engine 208 determines that the identifier received in the identification data matches at least one of the identifiers 222 stored in the second memory 120. The data processing engine 208 may be further configured to identify, from the historical data 224, one of the default lifecycles 228 that corresponds to the matched identifier. In other words, the data processing engine 208 may be configured to retrieve the default lifecycle of the item and/or activity from the historical data 224 of the item and/or activity based on the matched identifier. The identified default lifecycle of the item and/or activity may include one or more predefined processes (hereinafter, interchangeably referred to as “the predefined processes”) associated with the item and/or the activity. Each of the predefined processes may have an associated throughput, e.g., each of the predefined processes may have an associated predefined completion time. The generated match signal may further include the identified default lifecycle. The data processing engine 208 may be further configured to transmit the generated match signal to the resource allocation engine 210 through the second communication bus 220.

In another embodiments, when the data processing engine 208 determines that the identifier received in the identification data does not match any of the identifiers 222 stored in the second memory 120, the data processing engine 208 may be configured to define a default lifecycle corresponding to the unmatched identifier. The data processing engine 208 may be further configured to generate a first error signal. The first error signal may include the unmatched identifier and the corresponding default lifecycle defined for the unmatched identifier. In another embodiment, the data processing engine 208 may be configured to transmit the generated first error signal to the data collection engine 206 and the notification generator 216 through the second communication bus 220. The first error signal may enable the data collection engine 206 to store the unmatched identifier and the corresponding default lifecycle defined for the unmatched identifier in the second memory 120. Upon successful storage of the unmatched identifier and the corresponding default lifecycle in the second memory 120, the data processing engine 208 may generate the match signal including the newly defined default lifecycle.

The match signal may cause the resource allocation engine 210 to identify and allocate the first set of resources from the resources 106 to each of the predefined processes based on the first set of attributes of the resources 106. For example, the resource allocation engine 210 may determine a capability of each resource 106 by analyzing the resource data 226 stored in the second memory 120, and select, from the resources 106, for each of the predefined processes, the first set of resources based on the determined capability. For example, the resource allocation engine 210 may be configured to determine if the predefined process is a transportation process or a transformation process. If the resource allocation engine 210 determines that the predefined process is a transportation process, the resource allocation engine 210 may be configured to allocate a resource (e.g., one of the first type of robotic systems 127a or the second type of robotic systems 127b) from the resources 106 that is capable of executing the transportation process. However, if the resource allocation engine 210 determines that the predefined process is a transformation process, the resource allocation engine 210 may be configured to allocate a resource from the resources 106 (e.g., one of the third type of robotic systems 127c and/or one of the process stations 128) that is capable of executing the determined transformation process.

In one embodiment, the first set of resources allocated to two different predefined processes may be same. In another embodiment, the first set of resources allocated to two different predefined processes may be partially same. In another embodiment, the first set of resources allocated to two different predefined processes may be mutually exclusive.

The resource allocation engine 210 may be further configured to communicate (or transmit) one or more commands to the first set of resources to cause the first set of resources to execute the corresponding predefined processes. In other words, the resource allocation engine 210 may be configured to transmit the one or more commands to the first set of resources over the communication network 110, such that under control of the received commands, the first set of resources executes the predefined processes.

In some embodiments, the detection engine 212 may be configured to receive, in real-time, detection data from detection devices (not shown) installed within the storage facility 124. In some embodiments, the detection devices may include the identification device 108, the user device 102, or one or more sensors installed in the storage facility 124. The detection engine 212 may be further configured to process the received detection data to detect, in real time, a value-added service requirement during the execution of the predefined processes. In other words, the detection engine 212 may detect, in real time, the value-added service requirement during the execution of the predefined processes based on the received detection data. For example, during a quality check process of an apparel, one or more images indicating a missing button on the apparel may be captured by image sensors in the storage facility 124. The detection engine 212 upon receiving the images may detect a value-added service requirement during the quality check process.

Upon detecting the value-added service requirement, the detection engine 212 may be configured to determine whether the detected value-added service requirement matches any of the historical value-added service requirements. In an embodiment, the detection engine 212 may determine that the detected value-added service requirement does not match any of the historical value-added service requirements. In such a scenario, the detection engine 212 may be configured to define a new value-added service for the mismatched value-added service requirement using at least one of a machine learning algorithm, an artificial intelligence technique, and the like. For example, if the item is an apparel and the value-added service requirement detected by the detection engine 212 is “loose threads”, the detection engine 212 may be configured to identify a corresponding value-added service from the value-added services 230 included in the historical data 224 of the apparel. However, if the detection engine 212 determines that the historical data 224 associated with the apparel does not include a value-added service for the detected value-added service requirement, the detection engine 212 may be configured to define a new value-added service that may facilitate in handling the mismatched value-added service requirement. In some embodiments, the detection engine 212 may be configured to generate a new service signal that may include the new value-added service defined for the mismatched value-added service requirement. Further, the detection engine 214 may be configured to transmit the generated new service signal to the data collection engine 206 through the second communication bus 220. In an embodiment, the new service signal may enable the data collection engine 206 to store the new value-added service defined for the mismatched value-added service requirement in the historical data 224 of the item and/or the activity stored in the second memory 120.

In another embodiment, the detection engine 212 may determine that the detected value-added service requirement matches with one of the historical value-added service requirements. In such a scenario, the detection engine 212 may be configured to generate a detection signal and communicate the generated detection signal to the process update engine 214 through the second communication bus 220. The detection signal may include the detected value-added service requirement.

The detection signal may enable the process update engine 214 to select a value-added service from the value-added services 230 stored in the second memory 120 that corresponds to the detected value-added service requirement. In other words, the process update engine 214 may select a value-added service that is stored corresponding to the identified item and/or activity and the value-added service requirement in a data storage table (not shown) in the second memory 120. The process update engine 214 may be further configured to modify the default lifecycle 224 of the item and/or activity by introducing the selected value-added service subsequent to at least one of the predefined processes (as shown in FIG. 3A). For example, when the identified default lifecycle includes a first predefined process and a second predefined process, the process update engine 214 may be configured to introduce the selected value-added service subsequent to the first predefined process and prior to the second predefined process.

In an exemplary scenario, the identified item may be an apparel. Based on a received detection signal, the process update engine 214 may determine that the value-added service requirement “wrinkles” was detected during a quality check process of the apparel. In such a scenario, the process update engine 214 may be configured to select “ironing” as the value-added service that may be stored corresponding to the “wrinkles” value-added service requirement in the historical data 224 of the apparel. Further, the process update engine 214 may be configured to introduce “ironing” as a value-added service after the quality check process and prior to the transportation of the apparel to the storage area 126. In an embodiment, if the selected value-added service requires transportation of the item to another process station, the process update engine 214 may be configured to select “transportation” as another value-added service for the apparel. The process update engine 214 may be configured to introduce “transportation” as a value-added service after the quality check process, followed by “ironing”. In other words, for one value-added service requirement, the process update engine 214 may select multiple value-added services that enable handling of the value-added service requirement.

In one embodiment, the selected value-added service may have a first throughput and a priority level associated therewith. Further, a first predefined process that immediately precedes the selected value-added service in the modified lifecycle may have a second throughput and a second predefined process that immediately succeeds the selected value-added service in the modified lifecycle may have a third throughput. For example, the first and second predefined processes may have corresponding predefined completion times.

The process update engine 214 may be further configured to generate an update signal that may include the modified lifecycle of the item and/or activity, the value-added service requirement, the selected value-added service, the first through third throughputs, and the priority level associated with the selected value-added service. Further, the process update engine 214 may be configured to communicate the generated update signal to the resource allocation engine 210 and the notification generator 216 through the second communication bus 220.

The resource allocation engine 210 may be configured to identify the second set of resources from the resources 106 to execute the selected value-added service(s). The resource allocation engine 210 may be configured to identify the second set of resources from the resources 106 based on the first set of attributes associated with each resource of the second set of resources, the second set of attributes associated with the selected value-added service, and the third set of attributes associated with the item and/or the activity. The first set of attributes may include a numerical count of resources in the second set of resources, a capacity, an availability, a condition, a type, a capability, and/or a real-time location of each of the second set of resources. The second set of attributes associated with the selected value-added service may include a type, a requirement, and/or a throughput of the selected value-added service. Further, the third set of attributes associated with the item and/or the activity may include a type of the item and/or the activity. The third set of attributes associated with the item may further include a size, a weight, one or more dimensions, a material, and/or a shape of the item.

The resource allocation engine 210 may be further configured to determine a capability of each resource 106 by analyzing the resource data 226 stored in the second memory 120. The resource allocation engine 210 may determine the capability of each resource 106 to identify the second set of resources from the resources 106 to execute the selected value-added service. The second set of resources are identified from the resources 106 such that the second set of resources is capable of executing the selected value-added service as per the priority level of the selected value-added service while preserving the first through third throughputs. In an embodiment, if the resource allocation engine 210 determines that the second set of resources are unavailable and the priority level of the selected value-added service is less than a priority level of a service and/or process being currently executed by the second set of resources, the resource allocation engine 210 may be configured to schedule the allocation of the second set of resources for a later time such that the second set of resources are automatically allocated to the selected value-added service having low priority level once the value-added service having the higher priority level is executed. However, if the resource allocation engine 210 determines that the second set of resources are unavailable and the priority level of the selected value-added service is greater than a priority level of a service and/or process being currently executed by the second set of resources, the resource allocation engine 210 may be configured to instruct the second set of resources to halt the ongoing service or process and execute the selected value-added service, thereby preserving the priority level of the selected value-added service.

The resource allocation engine 210 may be further configured to transmit one or more commands to each of the second set of resources to cause the second set of resources to execute the selected value-added service. In other words, the resource allocation engine 210 transmits the commands over the communication network 110 (as shown in FIG. 1A), and under control of the received commands, the second set of resources may execute the selected value-added service.

The notification generator 216 may be configured to communicate with the process update engine 214 to retrieve data representing an allocation of the second set of resources to the selected value-added service. The notification generator 216 may be configured to generate a notification that is indicative of (or includes) the default lifecycle of the item and/or the activity, the modified lifecycle of the the item and/or activity, the identified value-added service requirement for the item and/or the activity, the selected value-added service, and the allocation of the second set of resources to the selected value-added service. The notification generator 216 may be further configured to define a timeout period for the generated notification. Specifically, the notification generator 216 defines the timeout period for the notification such that the notification is valid till exhaustion (or expiry) of the timeout period. Further, the notification generator 216 may be configured to transmit the generated notification to the user device 102 (as shown in FIG. 1A) of the user. The generated notification may be communicated to the user device 102 over the communication network 110 using a method such as, but not limited to, a text message, a push notification, an email, a voice message, and the like.

Referring now to FIG. 3A, a block diagram that illustrates the administrator dashboard 300 of the RM application 116, according to an embodiment of the present disclosure, is shown. The RM application 116 may be configured to receive the notification from the control server 104 that may be presented to the user through the administrator dashboard 300 displayed on the user device 102. The administrator dashboard 300 of the RM application 116 displayed on the user device 102 may enable the user associated with the user device 102 to provide feedback corresponding to the notification. The administrator dashboard 300 may include options such as but not limited to, an identifier section 302, a modified lifecycle section 304, a detected value-added service requirement tab 306, a selected value-added service tab 308, an allocated service tab 310, an accept tab 312, a deny tab 314, and a feedback tab 316. In the illustrated embodiment of FIG. 3A, the identifier section 302 may be configured to display the identified identifier associated with the item and/or activity received in the notification. Further, the modified lifecycle section 304 may be configured to display the modified lifecycle associated with the item and/or the activity. In an exemplary scenario, the modified lifecycle 318 may include a default lifecycle of the item and/or activity along with the selected value-added service 320 introduced subsequent to the first predefined process 322, and prior to the second predefined process 324 of the default lifecycle. Furthermore, the detected value-added service requirement tab 306, the selected value-added service tab 308, and the allocated service tab 310 may be configured to display the detected value-added service requirement, the selected value-added service 320 and the second set of resources allocated to the selected value-added service 320, respectively.

In the illustrated embodiment of FIG. 3A, the processor 114 of the user device 102 may enable the accept tab 312 to enable the user to accept the notification and the corresponding modified lifecycle, the selected service, and the allocated second set of resources. The processor 114 may be configured to generate the acceptance signal in response to the user activating (or selecting) the accept tab 312. Further, the generated acceptance signal may be transmitted (or communicated) from the user device 102 to the feedback engine 218 of the control server 104 over the communication network 110 (as shown in FIGS. 1A and 1B). In another embodiment, the processor 114 may be configured to generate a decline signal in response to the user activating (or selecting) the deny tab 314. The generated decline signal may be transmitted from the user device 102 to the feedback engine 218 of the control server 104 over the communication network 110 (as shown in FIGS. 1A and 1B)

Referring back to FIG. 2, the feedback engine 218 may be configured to determine a response time at the user device 102 based on the received acceptance signal. The response time may be defined as a time duration from the transmission of the notification to the user device 102 to the reception of the acceptance signal at the feedback engine 218. In an embodiment, if the feedback engine 218 determines that no acceptance signal or feedback is received from the user device 102 within the timeout period, the feedback engine 218 may be configured to generate a timeout signal. In other words, the feedback engine 218 may be configured to generate the timeout signal at expiry of the timeout period. In some embodiments, the timeout signal may include a predefined message such as, but not limited to, “Timeout!, process modified automatically”, or the like. The feedback engine 218 may be configured to transmit the generated timeout signal to the user device 102 to notify the user. The feedback engine 218 may be configured to further modify the default lifecycle by introducing the selected value-added service subsequent to, and between the first predefined process and the second predefined process of the default lifecycle as discussed above. However, if the feedback engine 218 determines that the determined response time is less than or equal to the associated timeout period of the notification, the feedback engine 218 may be configured to transmit the acceptance signal to the process update engine 214. In some embodiments, the acceptance signal may enable the process update engine 214 that may be configured to modify the default lifecycle of the item and/or activity according to the data in the notification.

Referring to FIG. 3A, if the user activates the feedback tab 316, the processor 114 may be configured to enable the user to manually enter recommendations corresponding to the detected value-added service requirement, the selected value-added service 320, the allocated second set of resources, or the like. In other words, the user may manually enter recommendations corresponding to the detected value-added service requirement displayed through the detected value-added service requirement tab 306. The recommendations may include, but are not limited to, a recommended value-added service, recommended resources corresponding to the recommended value-added service, and the like. The processor 114 may be configured to generate a feedback signal having the recommended value-added service and/or the recommended resources. Further, the processor 114 may be configured to transmit the generated feedback signal to the control server 104 over the communication network 110. In one embodiment, the feedback provided by the user may include a declaration that the value-added service requirement was a false positive. The feedback signal may enable the notification generator 216 to transmit the generated feedback signal to the process update engine 214 and the resource allocation engine 210 through the second communication bus 220.

Referring back to FIG. 2, the feedback signal may enable the process update engine 214 to select the value-added service or deselect the value-added service further based on the received feedback. In other words, the process update engine 214 may be configured to select the recommended value-added service received in the feedback signal from the value-added services 230 stored in the second memory 120. Similarly, the feedback signal may enable the resource allocation engine 210 to select the set of recommended resources from the resources 106 corresponding to the recommended value-added service received in the feedback signal. The process update engine 214 may be further configured to modify the default lifecycle of the item and/or the activity in response to the selected value-added service based on the received feedback. In such embodiment, the process update engine 214 may be further configured to generate a modified lifecycle signal that may include the modified lifecycle, the selected value-added service, and the second set of resources allocated to the selected value-added service. Further, the process update engine 214 may be configured to transmit the generated modified lifecycle signal to the resource allocation engine 210 through the second communication bus 220.

Upon receiving the modified lifecycle signal, the resource allocation engine 210 may be further configured to determine an additional resource requirement for at least one of the first predefined process and the second predefined process due to the introduction of the selected value-added service. The resource allocation engine 210 may be configured to determine the additional resource requirement based on the corresponding throughputs of the first predefined process and the second predefined process. For example, if the item is an apparel, the default lifecycle associated with the apparel may include a first predefined process, e.g., a folding process, and a second predefined process, e.g., a packaging process. The first predefined process may have the second throughput and the second predefined process may have the third throughput. The resource allocation engine 210 may be configured to identify the third set of resources from the resources 106 capable of executing the folding process or the packaging process while preserving the second and third throughputs that may be disturbed due to the introduction of the selected value-added service such as “ironing process” after the folding process and before the packaging process. The preservation of the first through third throughputs by allocating the third set of resources of the resources 106 may eliminate chances of starvation at the process stations 128 where the first and the second predefined processes are executed. In other words, if the resource allocation engine 210 determines that the additional resource requirement is for the first predefined process, the resource allocation engine 210 may allocate the third set of resources to the first predefined process. However, if the resource allocation engine 210 determines that the additional resource requirement is for the second predefined process, the resource allocation engine 210 may allocate the third set of resources to the second predefined process. The resource allocation engine 210 thus allocates the identified third set of resources to execute the first predefined process or the second predefined process such that the third set of resources executes the first predefined process or the second predefined process while preserving the first through third throughputs. In other words, the resource allocation engine 210 allocates the identified third set of resources to execute the first predefined process based on the attributes of each resource of the third set of resources such that each of the third set of resources executes the first predefined process while preserving the first through third throughputs. Similarly, the resource allocation engine 210 may allocate the identified third set of resources to execute the second predefined process.

Additionally, the resource allocation engine 210 may be further configured to determine whether resources allocated to the second predefined process are in excess due to the introduction of the selected value-added service. The resource allocation engine 210 may be configured to determine the excess resources allocated to the second predefined process that succeeds the value-added service based on the second throughput of the second predefined process. In such a scenario, the resource allocation engine 210 may reallocate one or more resources from the first set of resources allocated to the second predefined process. Similarly, the control server 104 continues to monitor and track each predefined process and value-added service executed in the storage facility 124 to gauge dynamically changing requirements and anomalies.

FIG. 3B is a block diagram that illustrates an exemplary scenario 326 of service enablement and resource allocation using the system 100, in accordance to the embodiments of the present disclosure. In the exemplary scenario 326, the item is assumed to be an apparel. The control server 104 may receive the identifier associated with the apparel, and identify from the historical data 224 associated with the apparel, a default lifecycle 328 of the apparel from the default lifecycles 228 based on the received identifier. The default lifecycle 328 is shown to include predefined processes (such as a quality check 330, packaging 332, and transporting 334 to the storage area 126) which are to be executed in a sequential manner. In a non-limiting example, it is assumed that the quality check 330 and packaging 332 could be executed at the same process station (e.g., the first process station 128a). The control server 104 further allocates the first set of resources from the resources 106 to each predefined process, quality check 330, packaging 332, and transporting 334.

During the execution of the predefined processes, the control server 104 may be configured to continuously receive identification and detection data from the identification device 108 and the detection devices. In one scenario, the detection data during quality check may indicate wrinkles on the apparel. In such a scenario, the control server 104 may configured detect a value-added service requirement “wrinkles detected” during the quality check 330. Based on the detected value-added service requirement, the control server 104 may select ironing service 336 as the value-added service to handle the “wrinkles detected” value-added service requirement. The control server 104 may then introduce the ironing service 336 after the quality check process 330 and before the packaging 332 of the apparel. Based on the selection of the ironing service 336, the control server 104 identifies the second set of resources from the resources 106 that is capable of executing the ironing service 336 and allocates the identified second set of resources to the selected value-added service.

In another exemplary scenario, during the transportation of a storage system from the storage area 126 to the first process station 128a by a robotic system of the first type of robotic systems 127a, the control server 104 may identify that a path to be followed by the robotic system from the storage area 126 to the first process station 128a is blocked. In such a scenario, the control server 104, in real time, may introduce a value-added service to cause the robotic system to take an alternate route to reach the first process station 128a.

In another embodiment, the control server 104 may detect that a load distribution at the first process station 108a executing order consolidation activity is higher than a preset threshold. In such a scenario, the control server 104 may detect a value-added service requirement for creating a new process station for order consolidation or executing order consolidation dynamically. Based on the detected value-added service requirement, the control server 104 may introduce a value-added service in the default lifecycle of the order consolidation activity for creating a new order consolidation station. Further, the control server 104 may allocate one or more resources from the resources 106 to execute the value-added service.

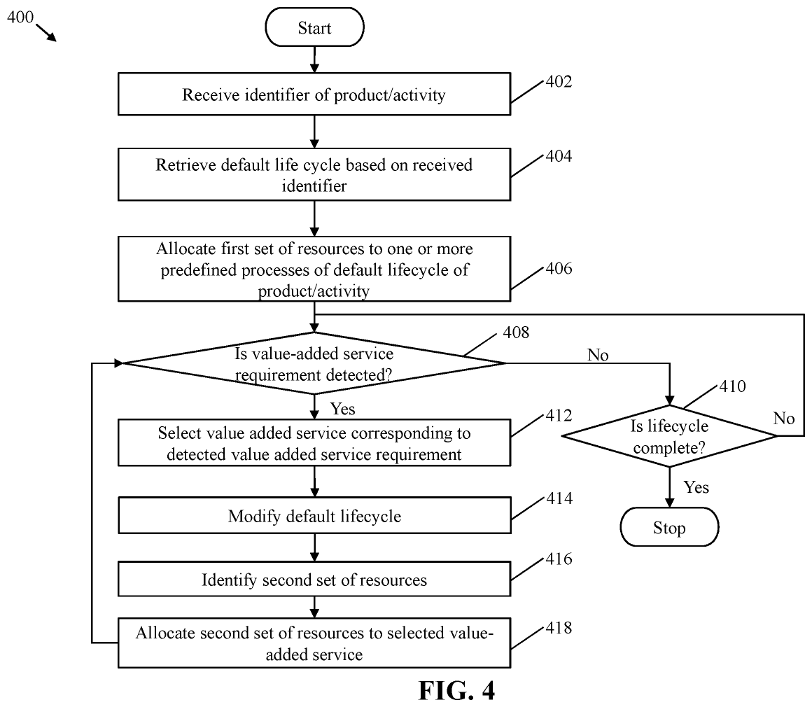

FIG. 4 represents a flow chart 400 that illustrates a method (i.e., a process) for service enablement and resource allocation, in accordance with an exemplary embodiment of the disclosure. Referring now to FIG. 4, the flow chart 400 may generally start at step 402, where the control server 104 may receive the identifier associated with the item and/or activity. The identifier may be received in the identification data captured by the identification device 108.

The process proceeds to step 404, where the control server 104 may retrieve the default lifecycle of the item and/or activity from the historical data 224 associated with the item and/or activity. The process further proceeds to step 406, where the control server 104 may allocate the first set of resources of the resources 106 to the one or more predefined processes of the default lifecycle of the item and/or activity. In some embodiments, the first set of resources are allocated to each of the one or more predefined processes based on the capability of each resource of the first set of resources to execute at least one of the one or more predefined process.

The process proceeds to step 408, where the control server 104 may determine whether the value-added service requirement is detected during the execution of the one or more predefined processes of the default lifecycle. If at step 408, the control server 104 does not detect any value-added service requirement, the process proceeds to step 410.

At step 410, the control server 104 may determine whether the default lifecycle (or the modified lifecycle) of the item and/or activity is complete. If at step 410, the control server 104 determines that the default lifecycle or the modified lifecycle of the item and/or activity is complete, the process proceed to end. If at step 410, the control server 104 determines that the default lifecycle or the modified lifecycle of the item and/or activity is not complete, the process returns to step 408.

If at step 408, the control server 104 detects a value-added service requirement, the process proceed to step 412. At step 412, the control server 104 may select, from the value-added services 230, the value-added service corresponding to the detected value-added service requirement. The process proceeds to step 414, where the control server 104 may modify the default lifecycle of the item and/or activity by introducing the selected value-added service subsequent to the first predefined process, and between the first predefined process and the second predefined process of the default lifecycle. The process proceeds to step 416, where the control server 104 may identify the second set of resources from the resources 106 capable of executing the selected value-added service.

The process further proceeds to step 418, where the control server 104 allocates the identified second set of resources to the selected value-added service. In some embodiments, the second set of resources is allocated to the selected value-added service based on a capability of each of the resource of the second set of resources to execute the selected value-added service. The process then proceeds to step 408.

Techniques consistent with the present disclosure provide, among other features a method and system for handling one or more objects arranged in a stack. While various exemplary embodiments of the disclosed system and method have been described above, it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the width or scope.

The system 100 for service enablement and resource allocation disclosed herein provides numerous advantages. The resources 106 disclosed herein provides for an easy and swift handling of items and/or activities while maintaining a throughput associated with each process associated with a lifecycle of the items and/or activities. The system 100 disclosed herein further provides a platform which enables different flexible insertion of value-added service (VAS) needed for each item and/or activities. Moreover, the system 100 provides flexibility in process flows that can be tweaked in case of a change in business need without significantly affecting the physical infrastructure. Further, the system 100 provides seamless integration with minimal lead time to provide an end-to-end value-added service enablement platform for handling different flows.

A person having ordinary skill in the art will appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. Further, the operations may be described as a sequential process, however some of the operations may in fact be performed in parallel, concurrently, and/or in a distributed environment, and with program code stored locally or remotely for access by single or multiprocessor machines. In addition, in some embodiments the order of operations may be rearranged without departing from the spirit of the disclosed subject matter.

Techniques consistent with the present disclosure provide, among other features, systems and methods for handling objects in a storage facility using a robotic manipulator. While various embodiments of the present disclosure have been illustrated and described, it will be clear that the present disclosure is not limited to these embodiments only. Numerous modifications, changes, variations, substitutions, and equivalents will be apparent to those skilled in the art, without departing from the spirit and scope of the present disclosure, as described in the claims.

1. A system for enablement of services and resource allocation in a storage facility, the system comprising:
a plurality of resources associated with the storage facility; and
a control server configured to:
store therein, an identifier and historical data of an item, wherein the historical data comprises at least one of a default lifecycle of the item and one or more value-added services historically executed with respect to the item;
receive the identifier associated with the item;
identify, from the historical data, the default lifecycle of the item based on the received identifier, wherein the default lifecycle comprises one or more predefined processes;
allocate a first set of resources from the plurality of resources to each of the one or more predefined processes for execution of each of the one or more predefined processes;
detect, in real-time, a value-added service requirement during the execution of at least one of the one or more predefined processes;
select, from the one or more value-added services, a value-added service based on the detected value-added service requirement;
modify the default lifecycle of the item by introducing the selected value-added service subsequent to at least one of the one or more predefined processes;
identify a second set of resources from the plurality of resources to execute the selected value-added service, based on at least one of a first set of attributes associated with each resource of the second set of resources, a second set of attributes associated with the selected value-added service, and a third set of attributes associated with the item; and
allocate the identified second set of resources to the selected value-added service.

2. The system of claim 1, wherein the first set of resources is allocated to each of the one or more predefined processes based on a capability of each resource of the first set of resources to execute a corresponding predefined process of the one or more predefined processes.

3. The system of claim 1, wherein the second set of resources is allocated to the selected value-added service based on a capability of each resource of the second set of resources to execute the selected value-added service.

4. The system of claim 1, wherein the first set of attributes comprises at least one of a numerical count of the resources in the second set of resources, a capacity, an availability, a condition, a type, a capability, and a real-time location of each resource of the second set of resources, wherein the second set of attributes comprises at least one of a type, a requirement, and a throughput of the selected value-added service, and wherein the third set of attributes associated with the item comprises at least one of a type, a size, a weight, one or more dimensions, and a shape of the item.

5. The system of claim 1, wherein the control server is further configured to:
generate a notification indicative of at least one of the default lifecycle of the item, the modified lifecycle of the item, the detected value-added service requirement, the selected value-added service, and the allocation of the second set of resources to the selected value-added service; and
transmit the notification to a user device of a user, wherein the notification has a timeout period associated therewith.

6. The system of claim 5, wherein the control server is further configured to modify the default lifecycle of the item further based on an acceptance signal received from the user device, and wherein the acceptance signal is received in response to an acceptance of the notification at the user device within the timeout period.

7. The system of claim 5, wherein the control server is further configured to modify the default lifecycle of the item further based on a timeout signal, and wherein the timeout signal is generated at expiry of the timeout period.

8. The system of claim 5, wherein the control server is further configured to receive a feedback from the user device corresponding to the detected value-added service requirement based on the notification, wherein the feedback comprises at least one of a recommended value-added service and a set of recommended resources of the plurality of resources corresponding to the recommended value-added service, and wherein the control server selects the value-added service further based on the received feedback.

9. The system of claim 1, wherein the selected value-added service is associated with a priority level such that the second set of resources capable of executing the selected value-added service is identified based on the priority level of the selected value-added service.

10. The system of claim 1, wherein the control server is further configured to transmit one or more commands to the first set of resources to cause the first set of resources to execute the corresponding one or more predefined processes.

11. The system of claim 1, wherein the control server is further configured to transmit one or more commands to the second set of resources to cause the second set of resources to execute the selected value-added service.

12. The system of claim 1, wherein the selected value-added service has a first throughput, a first predefined process of the one or more predefined processes that immediately precedes the selected value-added service in the modified lifecycle has a second throughput, and a second predefined process of the one or more predefined processes that immediately succeeds the selected value-added service in the modified lifecycle has a third throughput.

13. The system of claim 12, wherein the control server allocates the second set of resources to execute the selected value-added service such that second set of resources executes the selected value-added service while preserving the first throughput, the second throughput, and the third throughput.

14. The system of claim 12, wherein the control server is further configured to:
determine an additional resource requirement for at least one of the first predefined process and the second predefined process due to the introduction of the selected value-added service;
identify a third set of resources of the plurality of resources capable of executing the first predefined process or the second predefined process; and
allocate the identified third set of resources to execute the first predefined process or the second predefined process such that the third set of resources execute the first predefined process or the second predefined process while preserving the first throughput, the second throughput, and the third throughput.

15. The system of claim 1, wherein the control server is further configured to receive the identifier associated with the item from at least one identification device.

16. The system of claim 1, wherein the control server is further configured to detect the requirement for the value-added service based on data received from at least one of an identification device or a user device.

17. The system of claim 1, wherein the control server is further configured to:
match the detected value-added service requirement with one or more historical value-added service requirements included in the historical data;
define a new value-added service for the detected value-added service requirement when the detected value-added service requirement is mismatched with the one or more historical value-added service requirements; and
store therein, the detected value-added service requirement and the defined new value-added service.

18. A method for enablement of services and resource allocation in a storage facility, the method comprising:
receiving, by a control server, an identifier associated with an item;
identifying, by the control server, from historical data associated with the item, a default lifecycle of the item based on the received identifier, wherein the default lifecycle comprises one or more predefined processes;
allocating, by the control server, a first set of resources from a plurality of resources associated with the storage facility to each of the one or more predefined processes for execution of the one or more predefined processes;
detecting, in real-time, by the control server, a value-added service requirement during the execution of at least one of the one or more predefined processes;
selecting, by the control server, from one or more value-added services included in the historical data, a value-added service based on the detected value-added service requirement;
modifying, by the control server, the default lifecycle of the item by introducing the selected value-added service subsequent to at least one of the one or more predefined processes;
identifying, by the control server, a second set of resources from the plurality of resources to execute the selected value-added service, based on at least one of a first set of attributes associated with each resource of the second set of resources, a second set of attributes associated with the selected value-added service, and a third set of attributes associated with the item; and
allocating, by the processing circuitry, the identified second set of resources to the selected value-added service.

19. A system for enablement of services and resource allocation in a storage facility, the system comprising:
a plurality of resources associated with the storage facility;
a control server configured to:
store therein an identifier and historical data of an activity, wherein the historical data comprises at least one of a default lifecycle of the activity and one or more value-added services historically executed with respect to the activity;
receive the identifier associated with the activity;
identify, from the historical data, the default lifecycle of the activity based on the received identifier, wherein the default lifecycle comprises one or more predefined processes;
allocate a first set of resources from the plurality of resources to each of the one or more predefined processes for execution of the one or more predefined processes;
detect, in real-time, a value-added service requirement during an execution of at least one of the one or more predefined processes;
select, from the one or more value-added services, a value-added service based on the detected value-added service requirement;
modify the default lifecycle of the activity by introducing the selected value-added service subsequent to at least one of the one or more predefined processes;
identify a second set of resources from the plurality of resources to execute the selected value-added service, based on at least one of a first set of attributes associated with each resource of the second set of resources, a second set of attributes associated with the selected value-added service, and a third set of attributes associated with the activity; and
allocate the identified second set of resources to the selected value-added service.

20. The system of claim 19, wherein the selected value-added service has a first throughput, a first predefined process of the one or more predefined processes that immediately precedes the selected value-added service in the modified lifecycle has a second throughput, and a second predefined process of the one or more predefined processes that immediately succeeds the selected value-added service in the modified lifecycle has a third throughput, and wherein the control server allocates the second set of resources to execute the selected value-added service such that second set of resources executes the selected value-added service while preserving the first through third throughputs.
